(19) United States
(12) Patent Application Publication
(10) Pub. No.: US 2025/0383255 A1
(43) Pub. Date: Dec. 18, 2025

(54) BALANCING DEVICE, SYSTEM AND METHOD

(71) Applicant: John Youngquist, Niagara Falls (CA)

(72) Inventor: John Youngquist, Niagara Falls (CA)

(21) Appl. No.: 19/241,340

(22) Filed: Jun. 17, 2025

Related U.S. Application Data
(60) Provisional application No. 63/660,778, filed on Jun. 17, 2024.

(51) Int. Cl. G01M 1/22; G01M 1/08

(52) U.S. Cl. CPC G01M 1/22; G01M 1/08

(57) ABSTRACT

A device, system and method for balancing a rotating object includes a balancing device having a balancing hub removably mounted onto the rotating object and a mass body releasably engaged with the balancing hub at a plurality of equidistant locations along an outer periphery of the balancing hub. A measurement unit is coupled to the rotating object to measure one or both of a vibration phase angle and an imbalance magnitude of the rotating object.

### CROSS-REFERENCE TO RELATED APPLICATIONS

The present application claims the benefit of U.S. provisional patent application 63/660,778 filed Jun. 17, 2024, entitled BALANCING DEVICE, SYSTEM AND METHOD, the entire disclosure of which is hereby incorporated by reference.

### TECHNICAL FIELD

The device, system and method disclosed herein relates generally to balancing a rotating object and, more specifically, to balancing machines with grinding wheels, machine shop grinders, metal surface grinders, and similar devices and systems.

### BACKGROUND

A rotating body is considered in balance if it rotates around its center of mass. This applies to wheels, tires, motor armatures, propellers, and other devices and systems. When the center of mass is displaced from the center of rotation, an imbalance is created that usually creates a vibration. A common procedure is to put a balance weight equivalent to the imbalance moment opposite the moment of imbalance, so the moments cancel. This eliminates or at least reduces the vibration. This process is widely used on car tires, for example. Other balancing procedures instead balance by removing mass, e.g. by drilling, machining, or grinding to restore balance and eliminate vibration.

In prior art systems/applications, determining the magnitude and position of an imbalance is necessary to eliminate it. This determination may be accomplished by vibration measurement, e.g. measuring displacement or acceleration of the test item. By way of example, a measurement signal may be generated and observed that is periodic with a fundamental frequency matching the rotation speed of the item. The vibration component will, in theory, be sinusoidal but may also likely contain various other contaminating signals and noise. Filtering such a signal with a bandpass centered on the vibration frequency, for example, may enhance the signal. The magnitude of the fundamental frequency is the strength of the vibration and the angular position of the imbalance is contained in the phase of the vibration signal. An index mark may be used to relate the phase of the signal to a physical location on a wheel. Magnetic or optical sensors may then be employed to generate a once per revolution index pulse. Should the phase of the waveform lag the index pulse by 60 degrees, for example, then the imbalance is centered 60 degrees past the index mark. The component may be balanced by positioning a correction weight 180 degrees past this imbalance point (i.e. at 240 degrees). The magnitude of the vibration indicates the size of the balance weight required, but the size of the weight cannot be determined by vibration magnitude alone. Even with the same imbalance, systems of different mass or different rigidity respond differently.

General purpose balance machines are available using the vibration measurement approach including an index mark to balance a variety of components. However, there remains no practical means to generate an index signal in many applications. For example and without limitation, such applications may include portable and temporary installations or systems where access to rotating elements is constrained or unreachable; or in cases when mounting, drilling or modifying the target device may not be possible.

With respect to machine shop surface grinders, modifications in the field to include an index mark sensor may be impractical. For this reason and others, there are no electronic balancers available for this application. Instead, wheels are often statically balanced with only modest improvement. Described herein is a balance measurement device, system and method to derive phase information in connection with a balance application without making any phase measurements and without a phase index signal. Exemplary embodiments of a system and method in accordance with the present disclosure may also be used in other applications previously unreachable or impossible, or for those applications where current modalities are cost prohibitive. In additional embodiments, the disclosed device, system, and methods may facilitate a device that needs no special mounting or installation. The disclosed device, system, and method may also be quickly moved from one application to another.

### BRIEF SUMMARY OF THE INVENTION

In one aspect, an exemplary device, method and system employs a measurement unit coupled to a rotating object for balancing the rotating object. The measurement unit is configured to measure one or both of a vibration phase angle of the rotating object and an imbalance magnitude of the rotating object. The measuring unit includes an accelerometer configured to measure a vibration of the rotating object. The measuring unit also includes a display and a processor. The processor has internal program storage and data storage and measures data from the accelerometer and outputs a vibration value to the display. The processor may also perform a Fast Fourier Transform operation on the measured data to output a frequency spectrum of vibration.

In a further aspect, a first measurement of the vibration of the rotating object is measured when the rotating object has a first mass difference, a second measurement of the vibration of the rotating object is measured when the rotating object has a second mass difference, and a third measurement of the vibration of the rotating object is measured when the rotating object has a third mass difference. The processor is programmed to perform a vector analysis of the first, second, and third vibration measurements to determine the phase angle of an imbalance of the rotating object. The first mass difference may be an increase or a decrease in mass at a first known location on the rotating object, the second mass difference may be an increase or a decrease in mass at a second known location on the rotating object different than the first known location, and the third mass difference is may be increase or a decrease in mass at a third known location on the rotating object different than each of the first known location and the second known location.

In another aspect of the present invention, a balancing device includes a balancing hub configured to be mounted onto a rotating object. The balancing hub is configured to selectively impart a mass differential to the rotating object at one or more of a plurality of locations along the balancing hub. In one embodiment, the balancing hub includes a 360-degree scale, and a mass body is adapted to releasably engage the balancing hub along an outer periphery of the balancing hub such that the mass body imparts the mass differential. The mass body may comprise a movable pair of balancing weights of equal weight configured to be selectively positioned at desired locations equidistant from the center of the hub about the 360-degree scale. In an alternative embodiment, the balancing hub includes an annular array of a plurality of bores wherein each successive bore may equidistantly spaced from an immediately adjacent bore of the plurality of bores. The plurality of bores may be 24 bores, wherein each bore is 15 degrees apart, on center, from the immediately adjacent bore and relative to the center of balancing hub. Each bore of the plurality of bores may also be tapped or threaded. The mass body may then include a threaded shaft adapted to be threadably received within a selected one bore of the plurality of bores. In a further aspect, each of the first, ninth and seventeenth bore of the 24 bores may include a respective first magnet, and wherein the balancing device further includes a reference mass body having a second magnet configured to releasably engage one of the respective first magnets of the first, ninth and seventeenth bores at a time.

In still another aspect of the present invention, a method for balancing a rotating object may include a) providing the rotating object having an imbalance; b) providing a measurement unit including an accelerometer; c) creating a first mass differential at a first known positions on the rotating object; d) measuring a first vibration using the accelerometer corresponding to the first mass differential; e) creating a second mass differential at a second known position on the rotating object; f) measuring a second vibration using the accelerometer corresponding to the second mass differential; g) creating a third mass differential at a third known position on the rotating object; h) measuring a third vibration using the accelerometer corresponding to the third mass differential; i) determining a phase angle of the imbalance using the measurements of the first vibration, the second vibration, and the third vibration; and j) determining a magnitude of the imbalance as a fraction of the first vibration, the second vibration, and the third vibration.

In a further aspect of the present invention, a balancing hub holds a grinding wheel and is configured to receive an adjustable pair of balancing weights. By rotating these weights around a spindle axis, their effective mass may be adjusted over a large range while also determining the angle of influence relative to a known location. In another aspect, an angular scale, graduated in degrees, is inscribed on the hub. In a preferred embodiment, the balancing weights are identical in mass and distance from the spindle center. As a result, positioning the weights 180 degrees apart places the balancing weights in perfect opposition such that the effective moment induced by the weights is cancelled and is zero.

### BRIEF DESCRIPTION OF THE SEVERAL VIEWS OF THE DRAWING(S)

FIG. 1 is a front perspective view of a first exemplary embodiment of a balancing hub in accordance with the disclosed device, system and method.

FIG. 2 is a front perspective view of the first exemplary embodiment of a balancing hub shown in FIG. 1 with balancing masses/weights mounted on the balancing hub.

FIG. 3 is a front plan view of a measurement unit used in conjunction with the balancing hub in accordance with the disclosed device, system and method.

FIG. 4 is a flow schematic for measuring vibration data using a balancing hub in accordance with the disclosed device, system and method.

FIG. 5 is a top plan view of a second exemplary embodiment of a balancing hub in accordance with the disclosed device, system and method.

FIG. 6 is a side view of the second exemplary embodiment of a balancing hub shown in FIG. 5.

FIG. 7 is a perspective view of a representative weight configured for use with the second exemplary embodiment of a balancing hub shown in FIG. 5.

FIG. 8 is a side view of the representative weight shown in FIG. 7.

FIG. 9 front view of the second exemplary embodiment of a balancing hub in accordance with the disclosed device, system and method with the balancing hub mounted onto a grinding wheel.

FIG. 10 is a flow schematic for measuring balance correction data using a balancing hub in accordance with the disclosed device, system and method.

FIG. 11 is a representative view of the display of the measurement unit showing wheel revolutions per minute (RPM) and vibration level in micro-G (μG).

FIG. 12 is a representative view of the display of the measurement unit showing the balance solution by displaying A, I and Q values, the calculation of the angle, and the magnitude of the vibration.

FIG. 13 is a representative view of the display of the measurement unit showing heavy screw type (H) and two letters to identify their locations (K & E) and a light screw type(S) with two letters for their locations (V & T).

FIG. 14 is a plan view of the measurement unit hardware.

### DETAILED DESCRIPTION OF THE INVENTION

A device, system and method for balancing a rotating object includes a balancing device configured to selectively impart a mass differential to the rotating object at one or more of a plurality of locations. a first measurement of the vibration of the rotating object is measured when the rotating object has a first mass difference, a second measurement of the vibration of the rotating object is measured when the rotating object has a second mass difference, and a third measurement of the vibration of the rotating object is measured when the rotating object has a third mass difference. The processor is programmed to perform a vector analysis of the first, second, and third vibration measurements to determine the phase angle of an imbalance of the rotating object. The first mass difference may be an increase or a decrease in mass at a first known location on the rotating object, the second mass difference may be an increase or a decrease in mass at a second known location on the rotating object different than the first known location, and the third mass difference is may be increase or a decrease in mass at a third known location on the rotating object different than each of the first known location and the second known location. A measurement unit is coupled to the rotating object to measure one or both of a vibration phase angle and an imbalance magnitude of the rotating object.

By way of example, equal mass differentials space 180 degrees apart from one another would result in their moment vectors cancelling one another. The mass differential may by formed by adding or removing weight from the rotating object. However, creating a mass differential of two identical masses at 170 degrees relative to one another, for example, the moments induced by the two mass differentials would no longer perfectly cancel but would allow a small part of the total mass differential to contribute to the effective moment. As the relative angle of the two mass differentials decrease from 170 degrees, the mass contribution to the effective moment increases until the two mass differentials are at 0 degrees such that they are coincident and contribute two times the individual mass to the effective moment. The effective mass contribution of the novel system is determined by the angle between the two matched mass differentials. Rotating the differentials along the circumference of the hub without changing the relative angle between the differentials is used to affect the angle of influence of the mass without changing the effective mass.

In a further aspect of the invention, the device, system and method described herein may also measure vibration with an accelerometer. In one aspect, the sensor may be mounted inside the device, with the device being mounted on the rotating object or a housing therefor to pick up vibration. In one embodiment, the vibration signal is enhanced and measured via operation of a Fast Fourier Transform (FFT).

In one aspect of the inventive system and method, determining the magnitude of the imbalance and its angle is a three-step process:
1. Set the mass differential to zero (no effect, 180 degrees therebetween) and measure vibration level (V_wheel). The instrument saves this value for future use. This is the wheel vibration alone.
2. Set the mass differential to 330 degrees and to 30 degrees respectively. Measure the vibration level (V_north). The instrument saves this value for future use. This is the sum of the wheel vibration, V_wheel, plus a constant component at 0 degrees.
3. Set the mass differential to 60 and 120 degrees. Measure vibration level (V_east). The instrument saves this value for future use. This is the sum of the wheel vibration, V_wheel, plus a constant component at 90 degrees.

It should be noted that positions other than 330/30 degrees and 60/120 degrees may be used as long as appropriate changes are made to the calculations.

In one aspect, vector analysis of the three vibration magnitudes, V_wheel, V_north and V_east, is completed as described in greater detail below and the system derives the phase angle of wheel imbalance. With magnitude and phase of the imbalance known, the settings of the mass differentials are calculated to oppose and cancel the vibration. The user creates the mass differentials on the rotating object at the calculated values to complete the balancing process.

For a given imbalance a certain moment will produce a certain level of vibration. The magnitude of the vibrations depends on various physical factors, such as but not limited to the system rigidity, wheel mass, instrument mounting, instrument calibration and others which are unique to the machine being used. In one non-limiting example, each count of vibration might require one ounce/inch of moment to correct for that vibration. In another example, a different wheel or a different machine may require a different correction. Once the magnitude and angle of the imbalance are calculated, the influence of the precisely known mass added in the first two steps can be determined and used as a scale factor for a precise correction calculation. This closed loop correction eliminates the need for absolute calibration of the device and accommodates variations from machine to machine.

The system and method described above depends on a calibration constant which is unknown. It should be first noted that the vibration measurement units are uncalibrated because an absolute numeric result is unnecessary. That is, the imbalance moment will act to displace the rotating object, e.g., a grinding wheel, based on the object's mass and mounting rigidity. This displacement motion is measured using an accelerometer. However, the relationship between the imbalance moment and the resulting vibration level is unknown. The imbalance magnitude is measured directly via the applied mass differentials onto the object while the imbalance angle is calculated in degrees using location of the mass differentials. To determine the size of the moment that will cancel the imbalance, the imbalance angle is known from the above but the moment size (mass at a distance) remains unknown. In one embodiment, a system and method utilizes three measurements to derive the exact moment magnitude (size) as a precise fraction of the test moments. The following measurements are taken:
1. With mass differentials absent or in zero influence position, measure and note the imbalance magnitude. This is referred to as the initial imbalance.
2. Position the mass differentials at 0 degrees-measure and note the imbalance magnitude (A).
3. Position the mass differentials at 120 degrees-measure and note the imbalance magnitude (B).
4. Position mass differentials at 240 degrees-measure and note the imbalance magnitude (C).

Using the measured values of A, B and C, Equation (1) is solved to derive the angle of the imbalance.

$$Angle = a tan 2 ( 2 {A}^{2} - {B}^{2} - {C}^{2} , {3}^{1 / 2} * {B}^{2} - {C}^{2} ) \qquad Equation ( 1 )$$

Then, the following equation (Equation 2) is used to derive the magnitude of the imbalance as a fraction of the test mass differentials utilized. This fraction is subsequently used to set the mass differentials on the rotating object to cancel the imbalance. As used herein, Abc is an abbreviation for (A²+B²+C²) and Sabc is an abbreviation for sin (A²+B²+C²).

$$Fraction = [ {3}^{1 / 2} * Abc * Sabc - {( 3 * {Sabc}^{2} - 9 * {( {B}^{2} - {C}^{2} )}^{2} )}^{1 / 2} ] / 3 * ( {B}^{2} - {C}^{2} ) \qquad Equation ( 2 )$$

The ratiometric nature of these calculations eliminates the need for any calibration of the vibration values and provides the correct correction angle values for test mass differentials of any size. In another aspect of the system and method, the angle setting A1 and A2 for the mass differentials may be determined by Equation (3) and Equation (4):

$$A 1 = Angle + 90 + arcsin ( Fraction ) - 360 \qquad Equation ( 3 )$$

$$A 2 = Angle - 90 - arcsin ( Fraction ) + 360 \qquad Equation ( 4 )$$

It should also be further noted that, in certain aspects, one or more of these equations may need a slightly different form to function well in all quadrants or to avoid special cases of divide by zero.

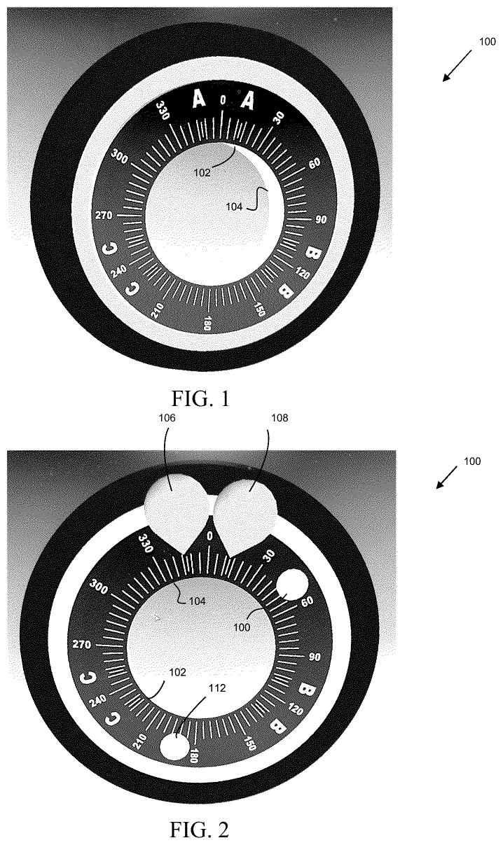

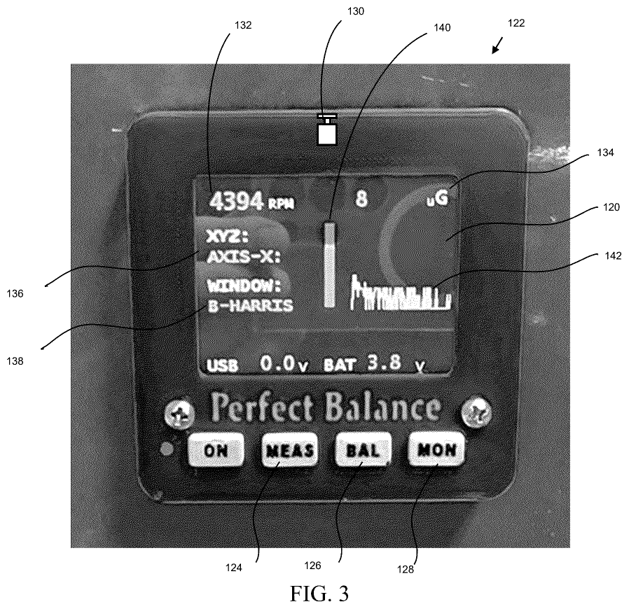

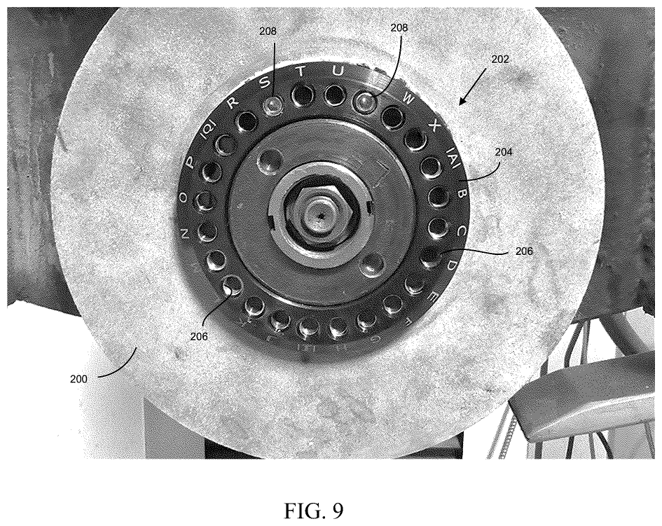

With reference to FIGS. 1 and 2, a non-limiting exemplary embodiment of a balance hub system 100 may serve several important purposes in accordance with the present invention. First, balance hub system 100 provides balancing hub 102 having a fixed-angular 360-degree scale which is the degree reference for all subsequent operations. Balance hub 100 includes a threaded bore 104 configured to maintain balance hub 100 in a fixed location on the wheel 200 (see e.g., FIG. 9) until removed. Second, balance hub 100 allows for positioning of two similar test masses 106, 108 at precise angular positions relative to each other and relative to scale 120 mounted on the grinding wheel. Test masses 106, 108 are used in the measurement process to determine the angle of the imbalance. Third, because balance hub 102 is fixedly attached to the wheel, the balance hub 102 facilitates positioning the test masses 106, 108 in a precise angular relationship to cancel the imbalance the wheel.

While shown and described as a separate hub and added weights, it should be understood by those skilled in the art that the weight differential generated in accordance with the present invention may be through addition or deletion of mass to the rotating object directly. That is, provision of a hub and mass bodies are not strictly required.

In one aspect, the masses 106, 108 may be held in the user-selected location by strong magnets that will prevent unwanted movement of the masses 106, 108. However, as a safety feature, masses 106.108 may be dislocated if touched while the wheel and balance hub 100 are in motion, thereby minimizing or preventing serious injury. In one aspect of the invention, balance hub 102 may be designed to replace or take the place of the existing hub nut being used to retain the grinding wheel on the spindle or shaft.

With reference to FIG. 2, balance hub 102 may also serve as an adjustable mass positioned at an adjustable angle relative to the grinding wheel. By way of example, balance hub 102 may include one or more, and preferably a pair, of balancing weights 110, 112 that, when rotated around the spindle axis, adjust their effective mass over a large range. Balancing weights 110, 112 may also determine the angle of influence relative to angular scale.

As described above, in one aspect, the disclosed system and method calculates the balance solution. With reference to FIG. 3, the two angles to be set on the balance hub 102 via masses 104, 106 and/or balancing weights 110, 112 are displayed on screen or display 120 of an exemplary measurement unit 122. In the exemplary embodiment of the measurement unit 122, the “MEAS” or measure button 124 is used to measure the vibration level without computing a balance. The “BAL” or balance button 126 may then be used to go through the three-measurement sequence described above to compute a balance by acquiring the A, B and C values. The “MON” or monitor button 128 may place measurement unit 122 into a low power mode that just monitors the vibration level while the machine is in operation so that a user can determine if the corrected vibration level is stable or increasing over time.

In a further aspect of the invention, measurement unit 122 may include an optional reference weight 130 configured to be placed in a storage location on measurement unit 122 when not in use. In this embodiment, reference weight 130 includes a small magnet which is attracted to a corresponding magnet in balancing hub 102. Balancing hub 102 may also include a magnetic hall effect sensor that signals the measurement unit 122 whether reference weight 130 is in its storage location or not. In a further aspect of the invention, the hall effect sensor may trigger the measurement unit 122 to signal the user to replace the reference weight within its storage location on the measurement unit 122 when weight 130 is no longer being used.

As further shown in FIG. 3, the exemplary display 120 may show various measured and/or observe phenomena of balancing hub 102, such as but not limited to hub RPM 132, vibration level (G) 134, the accelerometer axis being tested (XYZ: Axis-A) 136, and the FFT being used (WINDOW: Blackman Harris) 138. In addition, a stability indicator/bar 140 may be located in the center of the display 120 to assist the user to determine when accurate readings may be taken using balancing hub 102 and measurement unit 122. Display 120 may also output a spectral display 142 which shows the FFT frequency spectrum of vibration.

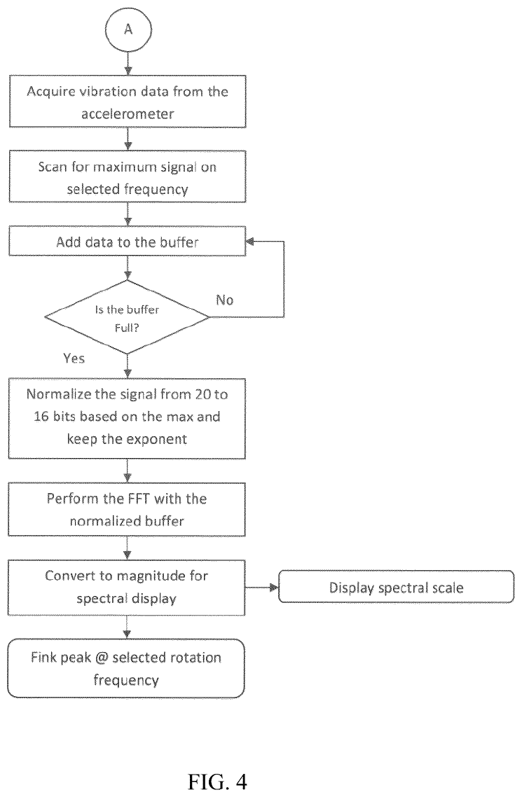

FIG. 4 shows a flow diagram for measuring and displaying the vibration data. Vibration data is collected by an accelerometer and scanned for a maximum signal at a selected frequency. Once the buffer is full, the signal is normalized and a FFT operation is performed to convert the magnitude data to a spectral display which is the outputted to the measurement unit 122 display 120.

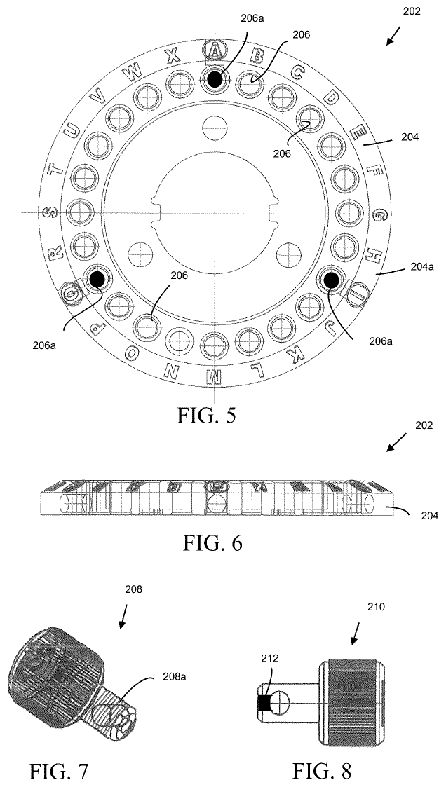

Referring now to FIGS. 5-8, another exemplary embodiment of balancing hub 202 generally comprises a disk 204 having an annular array of a plurality of bores 206, with each successive bore 206 being equidistantly spaced from another around the outside edge 204a of disk 204. In this embodiment, the disk 204 may be constructed of any suitable material, such as a metal, composite or polymer, and in one embodiment is fabricated from aluminum. Disk 204 may also be dimensioned according to its intended purpose, and in one embodiment has an outer diameter of approximately 3 inches (7.62 cm) and may include 24 bores equally spaced around the disk in 15-degree intervals (360°/24). Each bore may be labelled with any suitable indicia so that a user can differentiate each bore, and in one non-limiting example the bores may be labeled alphabetically with letters A to X. Each bore 206 may also be tapped or threaded to threadably receive threads 208a of balancing mass or weight 208. Set screws or bolts of differing lengths may be used to achieve a range of various masses or weights that can be mounted onto disk 204. In one exemplary embodiment, a series of weights (screw lengths) is selected to provide weights ranging from a high of about 4 grams to about 100 milligrams.

In its simplest iteration, disk 204 may be used with a balance stand to manually balance a wheel using bolts or screws 208 as the balancing weight(s). In certain aspects, different screw lengths or multiple screws may be used to achieve balance. Screw placement and configuration may be determined by trial and error with the wheel on an arbor and balance stand. By way of example, the user may insert a screw 208 in a bore which results in the wheel experiencing a fixed moment at a given angle. Thus, combining screws delivers different moments and the user can iteratively improve the balance of the wheel. However, if disk 204 is used in this manner, results are not likely precise.

In one exemplary embodiment of the method, measurement unit 122 may be used to collect measured data from the wheel to correct the balance rather than merely estimating improved balance through visual interrogation and trial-and-error. Measurement unit 122 may thus provide consistent results, and in one embodiment, a better than 7.5-degree resolution in the first phase correction. However, even better resolution may be obtained through a second phase correction, as described below.

The goal of the method is to match the wheel imbalance as closely as possible to cancel the balance and achieve best possible balance. While giving satisfactory results, the use of only 24 bores and screws having different weights may limit the adjustment resolution. In order to achieve a 100 times improvement in balance, the moment must be matched within 1%. On the improved disk or wheel, we have only 5 angular steps (tapped bore positions) between 0°-90° and, using five different screw weights, results in 25 possible masses over our entire range (with some overlap, less than 20 are useful). Without additional steps, therefore, matching within 1% with 20 choices is not likely.

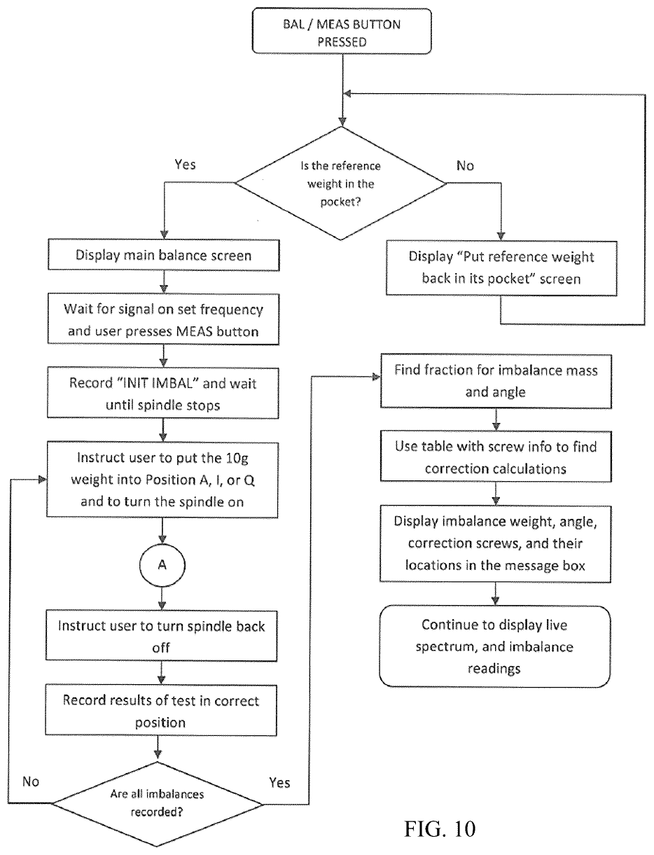

With additional reference to FIG. 10, balancing the wheel is accomplished by putting a counter mass in the hub which matches in opposition the imbalance of the wheel that amounts to a moment, or in this case, a mass at an angle. The angle and mass are computed from the balanced equations based on the three inputs A, B, and C, in the case of embodiment of alphabetized disk 202 the A, I and Q values. The three measurements with the reference weight are positioned at 120-degree intervals for one another. In one aspect of the invention, a large pair of balance weights and a small pair of balance weights are provided. The large weights may be used to generate a coarse adjustment in accordance with the limits of their resolution, and then a second adjustment process is used using smaller lighter weights to fine-tune the result to a better value.

Higher resolution balancing may use two separate corrections performed sequentially. First, a first of balance screw/weight 208 is selected wherein the mass of screw 208 is slightly greater than half the imbalance mass. The effective mass of this weight 208 is tuned by adjusting the weight to match as closely as possible the imbalance mass of the wheel and to align the weight as close as possible to 180 degrees from the imbalance angle, so that the weight 208 effectively cancels the imbalance. Once the first weight 208 has been mounted to the balancing disk 202, the correction vector is subtracted from the imbalance vector to create an error vector. The error vector is a reflection on the resolution of the first phase correction. In one aspect, the error vector may be further refined through a second phase correction which is similar to the first phase correction but using a pair of smaller, lighter screws. Screw weight for the second set of screws 206 is selected based on the error vector mass and may typically be a factor of 2 to 3 times smaller (e.g., grams to milligrams). The first correction may be considered a coarse correction and the second correction to be a fine correction.

It is possible that the second adjustment screw positions might conflict with the previous screw position(s) of the first set of screws. However, this is avoided by favoring over correction in the first phase so subtraction is used in the second phase to correct the error. Subtraction is carried out by placing the second set of weights in the opposite 180 degrees of the hub, thus avoiding conflicts with the first set of screws. The second phase correction is based on the error vector from the first, so both magnitude and angle are considered and corrected. With a smaller screw for the second correction, finer adjustment of the balance may be achieved.

In a further aspect of the invention, a precisely weighted reference mass/weight 210 is placed in a threaded bore 206 but does not engage the threads. Instead, reference weight 210 includes a magnet 212 that is retained by corresponding magnet 206a in each of threaded bores 206A, 206I and 206Q for easy installation and removal. Reference weight 210 may be used in the calculation of the the A, I and Q values and be removed after the last measurement is recorded. Reference weight 210 may then be removed and the the specified balance screws may be threadably installed on disk 204. With additional reference to FIG. 10, this process may be summarized as:
1. Remove all screw weights and reference weights. Measure uncorrected imbalance. The instrument will record this as the reference imbalance.
2. Put the reference weight in location A. Measure resulting imbalance. The instrument will record this as measurement A.
3. Move the reference weight to location I. Measure resulting imbalance. The instrument will record this as measurement I.
4. Move the reference weight to location Q. Measure resulting imbalance. The instrument will record this as measurement Q.
5. The instrument will process the A, I, Q values and determine the balance correction solution in accordance with the method described herein.
6. Remove the reference weight and install the indicated correction weights to balance the wheel.

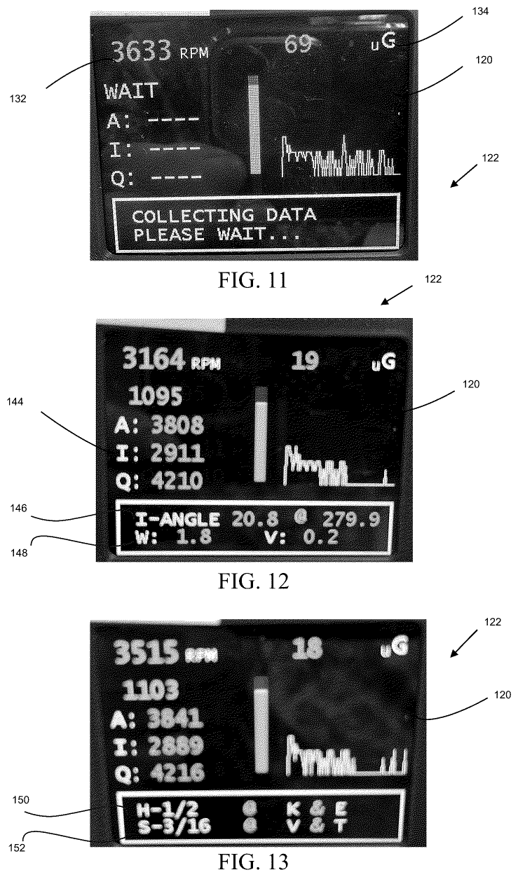

FIGS. 11-13 illustrate various outputs which may be displayed on the instrument display 120 of measurement unit 122. FIG. 11 shows hub RPM 132 and vibration level (uG) 134 while measurement unit 122 is collecting data. In FIG. 12, measurement unit 122 reports the balance solution by displaying A, I and Q values 144, the calculation of the angle 146, and the magnitude of the vibration 148. FIG. 13 displays heavy screw type (H) and two letters to identify their respective locations (K & E) 150 and a light screw type(S) with two letters for their respective locations (V & T) 152. With this displayed information, the user may install the identified screws in the specified bores to complete the balancing of the wheel.

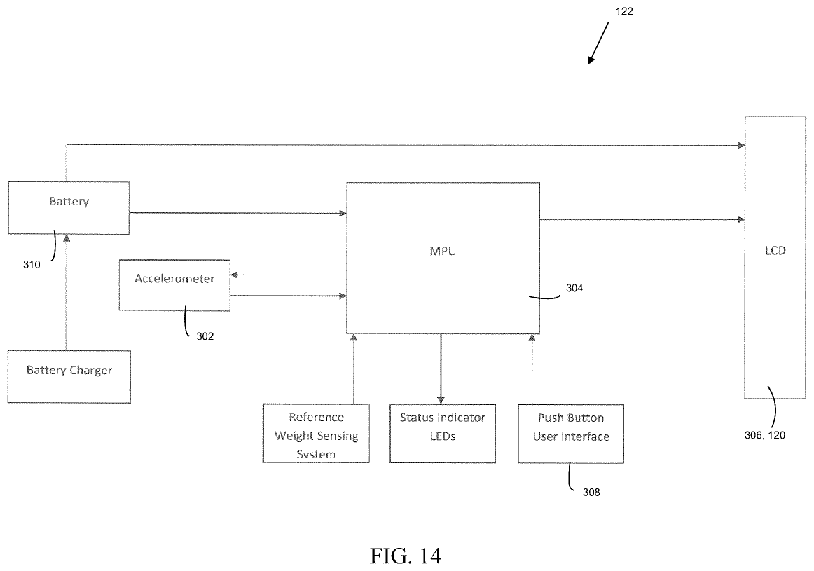

With reference to FIG. 14, measurement unit 122 hardware generally comprises an accelerometer 302, processor 304 and display 306 (120). There are a few other subordinate elements like push buttons 308 and battery 310 for power supply. Accelerometer 302 may be a monolithic integrated circuit that has either an analog or a serial digital output, such as but without limitation thereto an Analog Devices ADXL355 (Analog Devices, Wilmington, Massachusetts). An analog output is measured by the microprocessor's on board analog-to-digital converter whereas the digital data device may convey the information to the processor over a built-in serial interface. Accelerometer 302 may be measured at a sample rate appropriate for the vibration frequency. While the Nyquist criteria would require the sample frequency to be twice the frequency of interest, in one aspect of the invention, the system and method may use a sample rate closer to 10 times vibration frequency, such as without limitation, 500 samples per second. Processor 304 may be an 8-bit design intended for embedded applications, such as an 8051 family-processor 304. Processor 304 may have its own internal program storage and data storage so external components are not necessary. Display 306 may be a small color LCD screen that is readily available at low cost. Data flow to the display may be conveyed over a parallel digital bus. All the hardware is powered by a 4-volt lithium battery 310, in one embodiment, that is regulated down to about 3 volts to supply the necessary power.

In an exemplary embodiment, processor 304 measures data from the accelerometer 302 on a continuous basis, buffering 512 samples at a time for further processing in one example. The software filters the signal from the accelerometer to isolate the vibration frequency and determine its magnitude. Averaging or other smoothing techniques known to those skilled in the art may be employed to give more accurate results. The measurement data is employed as previously described to derive the balance solution.

Under ideal situations, measuring imbalance may be relatively easy, but under real world conditions it may not be. One potential problem is that the signal the system is trying to measure may be contaminated by noise from various sources. The noise can come in the form of electrical noise or mechanical noise. Mechanical noise that is very close to the frequency of interest is particularly troublesome. The most common speed for a surface grinder spindle is 3600 RPM, which corresponds to sixty revolutions per second (60 Hertz (Hz)) which is also the AC line frequency. Machines such as pumps, motors, cooling fans and transformers are all powered by the same 60 Hz line frequency so are likely to produce interfering vibration at that frequency. These interfering vibrations add to and contaminate real world measurements. It is further noted that it is unlikely that interfering sources will be exactly synchronous with the rotation rate of the motor. As a result, the interfering frequencies will not be a perfect match but may still be very close to cause measurement errors. Further, a beat frequency may be generated which will modulate the measurement at a slow rate such that measurement readings may jump up and down.

While there is no obvious way to isolate the contaminating frequency from the frequency of interest, some grinders have variable frequency drives, allowing for adjustment of motor speed over a wide range. If a drive frequency of 60 Hz is a problem, changing it to 55 Hz, for example, may avoid the interference and provide a noise-free measurement. Similarly, the drive frequency may be increased above 60 Hz to avoid the contamination problem. However, for grinders that that operate at a fixed frequency, no simple avoidance strategy is available. In one exemplary embodiment of the disclosed device, system and method, the system and method surveys the acquired frequency spectrum at frequencies below the spindle speed, looking for a quiet spot (i.e. little to no contaminating frequencies). If there were no interfering sources at 55 Hz, for example, measurement unit 122 may be configured to record data when the machine rotates at 55 Hz. That is, the user may turn off the machine spindle and allow the spindle to coast to a stop. As the spindle decelerates, it will pass through the 55 Hz band. The system and method may then capture measurements at 55 Hz which are uncontaminated by noise. This technique avoids noisy areas by seeking out the best place to acquire noise-free data, and improves the method and system described herein.

Although the present description is set forth in terms of the rotating wheels, such as grinding wheels, it is contemplated that the device, system and methods disclosed herein can be operably connected to a variety of rotating devices, such as but not limited to wheels, tires, motor armatures, propellers, and other devices and systems.

This disclosure has been described in detail with particular reference to an embodiment, but it will be understood that variations and modifications can be affected within the spirit and scope of the disclosure. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed is:

1. A method for balancing a rotating object, the method comprising:
a) providing the rotating object having an imbalance;
b) providing a measurement unit including an accelerometer;
c) creating a first mass differential at a first known position on the rotating object;
d) measuring a first vibration using the accelerometer corresponding to the first mass differential;
e) creating a second mass differential at a second known position on the rotating object;
f) measuring a second vibration using the accelerometer corresponding to the second mass differential;
g) creating a third mass differential at a third known position on the rotating object;
h) measuring a third vibration using the accelerometer corresponding to the third mass differential;
i) determining a phase angle of the imbalance using the measurements of the first vibration, the second vibration, and the third vibration;
j) determining a magnitude of the imbalance as a fraction of the first vibration, the second vibration, and the third vibration; and
k) calculating via a computer implemented algorithm a balance solution using the determined phase angle and magnitude of the imbalance.

2. The method of claim 1, further comprising displaying the balance solution to a user whereby the user uses the balance solution to balance the rotating object.

3. The method of claim 1, wherein the measurement unit includes a processor programmed to execute the algorithm to determine the phase angle of the imbalance using the equation:
$$Phase Angle = a tan 2 ( 2 {A}^{2} - {B}^{2} - {C}^{2} , {3}^{1 / 2} * {B}^{2} - {C}^{2} )$$
wherein A is the magnitude of the imbalance at the first measurement; B is the magnitude of the imbalance at the second measurement; and C is the magnitude of the imbalance at the third measurement.

4. The method of claim 3 wherein the processor is programmed to execute the algorithm to determine the magnitude of the imbalance using the equation:
$$Fraction = [ {3}^{1 / 2} * Abc * Sabc - {( 3 * {Sabc}^{2} - 9 * {( {B}^{2} - {C}^{2} )}^{2} )}^{1 / 2} ] / 3 * ( {B}^{2} - {C}^{2} ) , where$$
$$Abc = ( {A}^{2} + {B}^{2} + {C}^{2} )$$
$$Sabc = sin ( Abc ) .$$

5. The measurement unit of claim 1, wherein the first mass differential is an increase or a decrease in mass at a first known location on the rotating object, the second mass differential is an increase or a decrease in mass at a second known location on the rotating object different than the first known location, and the third mass differential is an increase or a decrease in mass at a third known location on the rotating object different than each of the first known location and the second known location.

6. The method of claim 1, wherein at least one of measuring the first vibration, measuring the second vibration, and measuring the third vibration is completed when the frequency of rotation of the rotating object is substantially free from noise as the rotating object decelerates.

7. The method of claim 1, wherein at least one of measuring the first vibration, measuring the second vibration, and measuring the third vibration is completed at a plurality of frequencies when the frequency of rotation of the rotating object is substantially free from noise as the rotating object decelerates, wherein the at least one of measured first vibration, measured second vibration, and measured third vibration undergoes statistical analyses to verify the integrity of the measurement data from each of the plurality of frequencies.

8. A method for balancing a rotating object, the method comprising:
a) providing the rotating object having an imbalance;
b) providing a balancing hub configured to be removably mounted onto the rotating object and a mass body adapted to releasably engage the balancing hub at a plurality of equidistant locations along an outer periphery of the balancing hub;
c) positioning mass body in a first known positions on the balancing hub;
d) providing a measurement unit including an accelerometer;
e) measuring a first vibration using the accelerometer;
f) repositioning the mass body a second known position on the balancing hub;
g) measuring a second vibration using the accelerometer;
h) repositioning the mass body a third known position on the balancing hub;
i) measuring a third vibration using the accelerometer;
j) determining a phase angle of the imbalance using the measurements of the first vibration, the second vibration, and the third vibration;
k) determining a magnitude of the imbalance as a fraction of the first vibration, the second vibration, and the third vibration; and
l) calculating via a computer implemented algorithm a balance solution using the determined phase angle and magnitude of the imbalance.

9. The method of claim 8, further comprising displaying the balance solution to a user whereby the user uses the balance solution to balance the rotating object.

10. The method of claim 8, wherein the measurement unit include a processor programmed to execute the algorithm to determine the phase angle of the imbalance using the equation:
$$Phase Angle = a tan 2 ( 2 {A}^{2} - {B}^{2} - {C}^{2} , {3}^{1 / 2} * {B}^{2} - {C}^{2} )$$
wherein A is the magnitude of the imbalance at the first measurement; B is the magnitude of the imbalance at the second measurement; and C is the magnitude of the imbalance at the third measurement.

11. The method of claim 10 wherein the processor is programmed to execute the algorithm to determine the magnitude of the imbalance using the equation:
$$Fraction = [ {3}^{1 / 2} * Abc * Sabc - {( 3 * {Sabc}^{2} - 9 * {( {B}^{2} - {C}^{2} )}^{2} )}^{1 / 2} ] / 3 * ( {B}^{2} - {C}^{2} ) , where$$
$$Abc = ( {A}^{2} + {B}^{2} + {C}^{2} )$$
$$Sabc = sin ( Abc ) .$$

12. A system for balancing a rotating object, the system comprising:
a) a balancing device including a balancing hub configured to be mounted onto the rotating object, wherein the balancing hub is configured to selectively impart a mass differential to the rotating object at one or more of a plurality of locations along the balancing hub; and
b) a measurement unit coupled to the rotating object, wherein the measurement unit is configured to measure one or both of a vibration phase angle of the rotating object and an imbalance magnitude of the rotating object.

13. The balancing device of claim 12, wherein the balancing hub includes a 360-degree scale.

14. The balancing device of claim 13, further comprising a mass body adapted to releasably engage the balancing hub along an outer periphery of the balancing hub, wherein the mass body imparts the mass differential.

15. The balancing device of claim 14, wherein the mass body comprises a movable pair of balancing weights of equal weight configured to be selectively positioned at desired locations equidistant from the center of the hub about the 360-degree scale.

16. The balancing device of claim 12, wherein the balancing hub includes an annular array of a plurality of bores.

17. The balancing device of claim 12, wherein each successive bore is equidistantly spaced from an immediately adjacent bore of the plurality of bores.

18. The balancing device of claim 17, wherein the plurality of bores is 24 bores, wherein each bore is 15 degrees apart, on center, from the immediately adjacent bore and relative to the center of balancing hub.

19. The balancing device of claim 17, wherein each bore of the plurality of bores is tapped or threaded, and wherein the mass body includes a threaded shaft adapted to be threadably received within a selected one bore of the plurality of bores.

20. The balancing device of claim 17, wherein each of the first, ninth and seventeenth bore of the 24 bores include a respective first magnet, and wherein the balancing device further includes a reference mass body having a second magnet configured to releasably engage one of the respective first magnets of the first, ninth and seventeenth bores at a time.

21. The balancing device of claim 18, wherein the measuring unit includes an accelerometer configured to measure a vibration of the rotating object.

22. The balancing device of claim 21, wherein the measuring unit includes a display and a processor the processor having internal program storage and data storage, wherein the processor measures data from the accelerometer and outputs a vibration value to the display.

23. The balancing device of claim 22, wherein the processor performs a Fast Fourier Transform operation on the measured data to output a frequency spectrum of vibration.

24. The balancing device of claim 23, wherein a first measurement of the vibration of the rotating object is measured when the rotating object has a first mass difference, a second measurement of the vibration of the rotating object is measured when the rotating object has a second mass difference, and a third measurement of the vibration of the rotating object is measured when the rotating object has a third mass difference; and wherein the processor is programmed to perform a vector analysis of the first, second, and third vibration measurements to determine a phase angle of an imbalance of the rotating object.

25. The balancing device of claim 24, wherein the processor is programmed to determine the phase angle of the imbalance using the equation:
$$Phase Angle = a tan 2 ( 2 {A}^{2} - {B}^{2} - {C}^{2} , {3}^{1 / 2} * {B}^{2} - {C}^{2} )$$
where A is the magnitude of the imbalance at the first measurement; B is the magnitude of the imbalance at the second measurement; and C is the magnitude of the imbalance at the third measurement.

26. The balancing device of claim 25, wherein the processor is programmed to determine a magnitude of the imbalance using the equation:
$$Fraction = [ {3}^{1 / 2} * Abc * Sabc - {( 3 * {Sabc}^{2} - 9 * {( {B}^{2} - {C}^{2} )}^{2} )}^{1 / 2} ] / 3 * ( {B}^{2} - {C}^{2} ) , where$$
$$Abc = ( {A}^{2} + {B}^{2} + {C}^{2} )$$
$$Sabc = sin ( Abc ) .$$

27. The balancing device of claim 26, wherein a first measurement of the vibration of the rotating object is measured when the mass body is at a first position on the balancing hub, a second measurement of the vibration of the rotating object is measured when the mass body is at a second position on the balancing hub, and a third measurement of the vibration of the rotating object is measured when the mass body is at a third position on the balancing hub; and wherein the processor is programmed to perform a vector analysis of the first, second, and third vibration measurements to determine a phase angle of an imbalance of the rotating object.
